(19) United States
(12) Patent Application Publication
(10) Pub. No.: US 2022/0051669 A1
(43) Pub. Date: Feb. 17, 2022

(54) INFORMATION PROCESSING DEVICE, INFORMATION PROCESSING METHOD, COMPUTER PROGRAM, AND INTERACTION SYSTEM

(71) Applicant: SONY CORPORATION, TOKYO (JP)

(72) Inventor: NORIHIRO TAKAHASHI, TOKYO (JP)

(21) Appl. No.: 17/275,667

(22) PCT Filed: Jun. 14, 2019
(86) PCT No.: PCT/JP2019/023644

§ 371 Date: Mar. 11, 2021

(30) Foreign Application Priority Data
Sep. 25, 2018 (JP) 2018-179521

(51) Int. Cl. G10L 15/22; G06K 9/00; G10L 15/25

(52) U.S. Cl. CPC G10L 15/22; G06K 9/00228; G10L 15/25; G06K 9/00335; G06K 9/00624; G06K 9/00302

(57) ABSTRACT

Provided are an information processing device, an information processing method, a computer program, and an interaction system for processing an interaction with a user. The information processing device includes a determination section that determines a state or a tendency of a user, and a decision section that decides an output to the user on the basis of a determination result obtained by the determination section. The determination section determines the state or the tendency of the user on the basis of a sensing result on the user or operation of an apparatus being used by the user. Further, the decision section decides a timing for talking to the user, a condition for talking to the user, or a speech for talking to the user.

### TECHNICAL FIELD

A technology disclosed in the present description relates to an information processing device, an information processing method, a computer program, and an interaction system for processing an interaction with a user.

### BACKGROUND ART

In recent years, a service which is called an “agent,” an “assistant,” or a “smart speaker” for providing various information to a user according to an application or a state while interacting with the user by using voices, etc., is becoming widespread. For example, agents that perform deputizing operations to turn on/off or control home appliances such as a light and an air conditioner, that make replies by voice to questions as to a weather forecast, stocks/exchange information, and news, that accept orders of products, and that read out loud the contents of purchased books, are known.

An agent function is provided by cooperation of an agent device which is put around a user in a house, for example, and an agent service which is constructed on a cloud (for example, see PTL 1). The agent device mainly provides user interfaces such as a voice input for receiving the voice of a user speech and a voice output for replying by voice to a question from a user. On the other hand, the agent service side executes high-load processes such as recognition and meaning analysis of a voice inputted to the agent device, an information search for a question from a user, and voice synthesis based on a process result.

Moreover, the agent device which directly interacts with a user may be formed as a dedicated device or may be any kind of information device having an agent application incorporated therein. Examples of such an information device include various kinds of CE equipment such as a television receiver, an air conditioner, a recorder, and a washing machine which are disposed indoors, an IoT (Internet of Thing device, a portable information terminal such as a smartphone or a tablet, an interaction-type robot, and a car navigation device which is installed in a vehicle (for example, see PTL 2).

To conduct a service of providing useful information to a user, an agent needs to collect more user information. For example, an interaction system for collecting user information through a natural conversation has been proposed (see PTL 3).

### CITATION LIST

### Patent Literature

[PTL 1]

JP-T-2017-527844
[PTL 2]

WO 2014/203495
[PTL 3]

JP 2003-196462A

### SUMMARY

### Technical Problems

An object of a technology disclosed in the present description is to provide an information processing device, an information processing method, a computer program, and an interaction system for processing an interaction with a user.

### Solution to Problems

A first aspect of the technology disclosed in the present description is an information processing device including

a determination section that determines a state or a tendency of a user, and

a decision section that decides an output to the user on the basis of a determination result obtained by the determination section.

The determination section determines the state or the tendency of the user on the basis of a recognition result about the user or operation of an apparatus being used by the user. Then, the decision section decides a timing for talking to the user, a condition for talking to the user, or a speech for talking to the user.

Further, a second aspect of the technology disclosed in the present description is an information processing method including

a determination step of determining a state or a tendency of a user, and

a decision step of deciding an output to the user on the basis of a determination result obtained by the determination step.

Further, a third aspect of the technology disclosed in the present description is a computer program that is written in a computer readable form to cause a computer to function as

a determination section that determines a state or a tendency of a user, and

a decision section that decides an output to the user on the basis of a determination result obtained by the determination section.

The computer program according to the third aspect defines a computer program that is written in a computer readable form to cause a computer to execute predetermined processes. In other words, when the computer program according to the third aspect is installed into the computer, a cooperative effect is exerted in the computer. Accordingly, the computer program can provide the effects similar to those provided by the information processing device according to the first aspect.

Further, a fourth aspect of the technology disclosed in the present description is an interaction system including

a recognition section that performs a recognition process of a user or operation of an apparatus being used by the user,

a determination section that determines a state or a tendency of the user on the basis of a recognition result obtained by the recognition section,

a decision section that decides an output to the user on the basis of a determination result obtained by the determination section, and

an output section that executes the output to the user on the basis of the decision.

The term “system” herein refers to a logical set of a plurality of units (or functional modules for implementing respective particular functions). Whether or not these units or functional modules are included in a single casing does not matter.

### Advantageous Effects of Invention

The technology disclosed in the present description can provide an information processing device, an information processing method, a computer program, and an interaction system for executing processes for proactively talking to a user and for responding to a reply result from the user.

It is to be noted that the effects disclosed in the present description are just examples, and the effects of the present invention are not limited thereto. In addition, any additional effect other than the above effects may be further provided.

Other objects, features, and advantages of the technology disclosed in the present description will become apparent from the more detailed description based on the embodiment and the attached drawings which are described later.

### BRIEF DESCRIPTION OF DRAWINGS

FIG. 1 is a diagram schematically depicting a functional configuration example of an interaction system 100.

FIG. 2 is a diagram depicting a modification of the interaction system 100.

FIG. 3 is a diagram depicting a schematic process flow for implementing a proactive speech making function in the interaction system 100.

FIG. 4 is a diagram depicting a case of implementing the proactive speech making function in the interaction system 100.

FIG. 5 is a diagram depicting a schematic process flow for implementing a feedback function to report a response result and a response state in the interaction system 100.

FIG. 6 is a diagram depicting an example of implementing the proactive speech making function based on deterioration in concentration of a visual line.

FIG. 7 is a diagram depicting an example of implementing the proactive speech making function based on positional information.

### DESCRIPTION OF EMBODIMENT

Hereinafter, embodiment of a technology disclosed in the present description will be explained with reference to the drawings.

To conduct a service of providing useful information to a user, an agent needs to collect more user information. An interaction system for collecting user information and questionnaire replies through interactions has been proposed (see PTL 3). However, in the conventional system, an interaction with a user is basically started by, as a trigger, a user's action of talking to the system. In other words, the system side cannot get information from the user unless the user talks to the system. Thus, opportunities to acquire information from the user, and acquirable information are limited. This causes a concern that both the quality and quantity of acquirable user information are insufficient. Moreover, if there is variation in the number of replies among users, a problem that statistical information is difficult to acquire is caused. In addition, there is a problem that the system cannot ask a user who has quitted proactively using an apparatus or a service in question, why the user has quitted. That is, it is impossible to approach a withdrawal user.

Further, the conventional interaction system basically does not include a mechanism for sending, to a user, a feedback about how user information is used after being collected through an interaction. Thus, a reward the user can obtain for a response made in response to an inquiry from the interaction system is the pleasure of an interaction only. Therefore, since motivation to give a reply is weak, there is a concern about reduction in the reply rate. Furthermore, the reply result from the user cannot be utilized for experience itself of the apparatus or the service.

With the foregoing in mind, an interaction system that is capable of proactively talking to a user and responding to a reply result from the user is proposed in the present description as follows. The interaction system provided in the present description has two main functions below.

(1) Proactive speech making function

(2) Feedback function

By the proactive speech making function, the interaction system proactively talks to a user about a subject and at a timing along the context on the basis of the state and the tendency of the user and a history. This interaction system having the proactive speech making function is capable of acquiring much more user information in more detail. In addition, the interaction system having the proactive speech making function is capable of acquiring a wide variety of user information from a silent majority (a majority group of people who do not aggressively express their opinions), and of asking a withdrawal user why the user has quitted proactively using the apparatus or the service.

Further, by the feedback function, the interaction system talks to a user to report a response result or a response state after responding to the reply result from the user. With the feedback function, motivation for a user to give a reply to talking started by the interaction system can be increased so that a barrier for the interaction system to ask the user's opinion may be lowered. Moreover, the opinion can be utilized for improving an apparatus having the interaction system installed therein or a service itself.

A. System Configuration Example

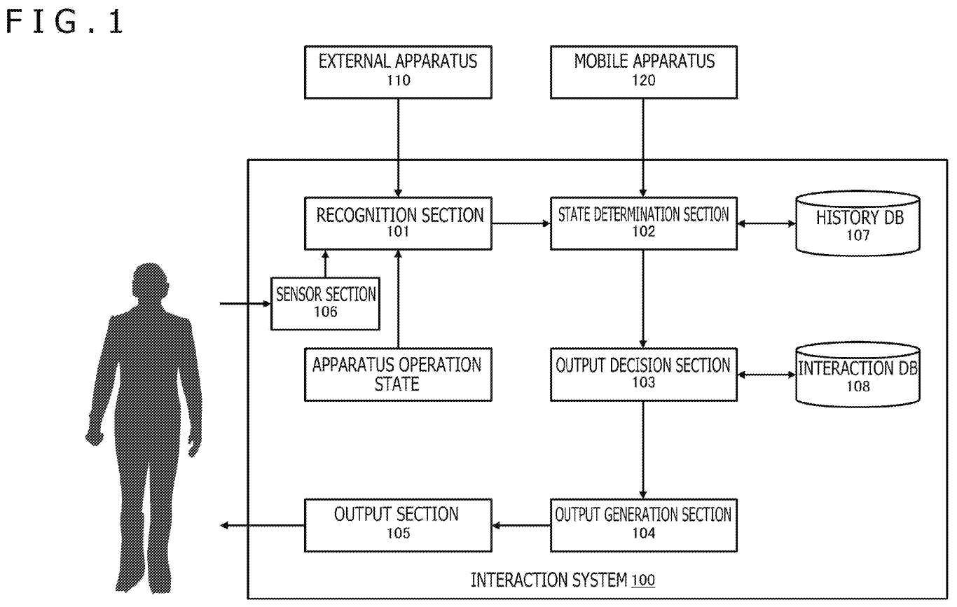

FIG. 1 schematically depicts a functional configuration example of an interaction system 100 to which the technology disclosed in the present description is applied. The interaction system 100 serves as an “agent,” an “assistant,” or a “smart speaker” to provide a voice-based service to a user. Particularly in the present embodiment, the interaction system 100 is characterized by having the proactive speech making function and the feedback function.

The depicted interaction system 100 includes a recognition section 101, a state determination section 102, an output decision section 103, an output generation section 104, and an output section 105. Further, the interaction system 100 includes a sensor section 106 including various sensor elements. Moreover, it is assumed that the interaction system 100 includes a communication interface (not depicted) that communicates, in a wired or wireless manner, with an external apparatus 110 that is disposed in a space, such as a living room, the same as that in which the interaction system 100 is disposed, or a mobile apparatus 120 with which the interaction system 100 interacts and which is owned by a user.

The sensor section 106 mainly senses information regarding an indoor environment in which the interaction system 100 is disposed. A specific configuration of the sensor section 106, that is, what sensor element is included in the sensor section 106 is determined as desired. Some or all of the sensor elements may be provided outside the interaction system 100. Further, the sensor section 106 may include a sensor element installed in the external apparatus 110 or the mobile apparatus 120. In the present embodiment, the sensor section 106 is assumed to include at least a camera, a proximity sensor, and a microphone.

Further, the sensor section 106 may include an infrared sensor, a human sensor, an object detecting sensor, a depth sensor, a biological sensor for detecting a user's pulse, sweat, brain waves, myogenic potential, exhaled breath, etc., or an environment sensor, such as an illuminance sensor, a temperature sensor, or a humidity sensor, for detecting environment information.

The external apparatus 110 is an electronic apparatus disposed in a space, such as a living room, the same as that in which the interaction system 100 is disposed. For example, the external apparatus 110 includes a television device, a recorder, a content reproducer such as a Blu-ray disk player, any other audio devices, and an agent device related to an agent service other than the interaction system 100. In addition, an IoT device disposed around the user may be included in the external apparatus 110.

The mobile apparatus 120 is an information terminal, such as a smartphone, a tablet terminal, or a personal computer, which is owned by the user. Further, an IoT device disposed around the user may be included in the mobile apparatus 120.

The recognition section 101 executes a recognition process of various sensor signals from the sensor section 106. Further, the recognition section 101 also executes a recognition process of an apparatus operation state in the interaction system 100 itself, the operation (e.g., a channel switching operation or a volume control operation to a television device, the controlled state of an image quality or a sound quality, and a content reproduction state) of the external apparatus 110, and the like. In addition, not only a case where a sensor signal is received from the external apparatus 110 or the mobile apparatus 120, but also a case where a result of sensor recognition performed by the external apparatus 110 or the mobile apparatus 120 is received assumed. Moreover, the recognition section 101 is assumed to also execute a sensor fusion process. In the present embodiment, the recognition section 101 executes, for example, at least user indoor position recognition, face recognition, face direction recognition, visual line recognition, and facial expression recognition in response to a sensor signal from a camera or a proximity sensor, and executes voice recognition, sound pressure recognition, voice print recognition, and emotion recognition of an inputted voice from a microphone. Further, the recognition section 101 outputs the recognition results to the state determination section 102.

The state determination section 102 determines the state of the user, a user's family member, or the like having an interaction with the interaction system 100 on the basis of the recognition results obtained by the recognition section 101. Specifically, the state determination section 102 determines the following states (1) to (4).

(1) The use state of the interaction system 100 itself and the use state of the external apparatus 110 (e.g., the content reproduction state)

(2) The position, the direction, the face direction, the movement amount, the visual line, the facial expression, etc., of the user or a family member in a room

(3) The position of each family member outside a room

(4) The conversation quantity of each of the user and the family member, the relative volume of a conversation sound, an emotion, and what is talked about in the conversation

Further, the state determination section 102 consults, as appropriate, a history database 107 storing history information in order to determine the above states. For example, the history database 107 includes the following history information (1) and (2).

(1) The operation histories and content reproduction histories of the interaction system 100 itself and the external apparatus 110

(2) A user profile (his or her family structure, preferences of each family member, questionnaire reply results, etc.)

It is assumed that history information in the history database 107 is sequentially updated. For example, each time the state determination section 102 makes determination on a state, the history information in the history database 107 is updated.

The output decision section 103 decides an output of the interaction system 100 on the basis of the states determined by the state determination section 102, that is, serves as an “agent,” an “assistant,” or a “smart speaker” to decide the following interaction actions (1) to (3).

(1) Timing for talking

(2) Condition for talking

(3) Speech for talking

Moreover, the output decision section 103 consults, as appropriate, an interaction database 108 storing interaction information in order to determine the above states. The interaction database 108 includes, as the interaction information, an interaction speech and a condition for starting the interaction speech. The condition for talking includes an interaction partner (e.g., a family member to whom the system talks) and a speaking mode (e.g., tone). It is assumed that the interaction information in the interaction database 108 is sequentially updated. For example, each time the output decision section 103 makes a decision about an output, the interaction information in the interaction database 108 is updated.

The output generation section 104 generates the output decided by the output decision section 103. The output section 105 executes the output generated by the output generation section 104.

The output section 105 includes a loudspeaker, for example, and executes the output by a voice. In a case of performing a voice output, voice synthesis of interaction information (text) decided by the output decision section 103 is performed at the output generation section 104, and the voice is outputted from the loudspeaker of the output section 105. In addition, the output section 105 may include a screen such that a video or an image (e.g., agent character) is displayed on the screen in combination with the voice. Moreover, the output section 105 may output the voice through an output device provided in the external apparatus 110 or the mobile apparatus 120 which is connected to the interaction system 100.

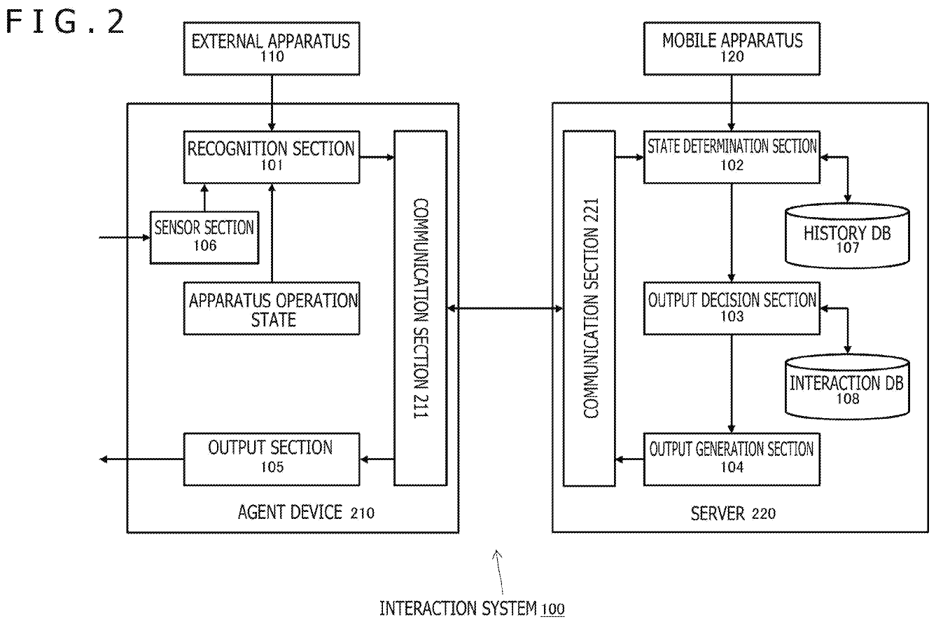

FIG. 2 depicts a modification of the interaction system 100. In the modification depicted in FIG. 2, the interaction system 100 includes an agent device 210 and a server 220.

The agent device 210 is disposed in a room, such as a living room, where a user or his or her family member who is an interaction partner is. On the other hand, the server 220 is set on a cloud. Further, in cooperation with the server 220, the agent device 210 provides an interaction service to the user. The agent device 210 is characterized by having the proactive speech making function and the feedback function.

In the modification depicted in FIG. 2, the agent device 210 includes the recognition section 101, the output section 105, and the sensor section 106, and further, includes a communication section 211 for establishing connection to a network such as the internet. The agent device 210 transmits a recognition result obtained by the recognition section 101, from the communication section 211 to the server 220 over the network. In addition, the agent device 210 receives, at the communication section 211, an interaction action decided by the server 220, over the network.

Further, in the modification depicted in FIG. 2, the server 220 includes the state determination section 102, the output decision section 103, and the output generation section 104, and further, includes a communication section 221 for establishing connection to a network such as the internet. The server 220 receives, at the communication section 221, the recognition result obtained by the agent device 210, over the network. In addition, the server 220 transmits the interaction action decided by the output decision section 103, from the communication section 221 to the agent device 210 over the network.

The configuration of the agent device 210 side and the configuration of the server 220 side should be designed in view of the expandability and responsiveness of the interaction system.

It is to be noted that the term “Cloud” in the present description generally refers to Cloud Computing. A cloud provides a computing service over a network such as the internet. In a case where the computing is implemented at a position, in the network, closer to an information processing device that receives the service, the computing is also referred to as Edge Computing or Fog Computing. The term “Cloud” in the present description may be interpreted to refer to a network environment or a network system for cloud computing (resources (including a processor, a memory, and a wireless or wired network connection facility) for computing). Alternatively, the term “Cloud” may be interpreted to refer to a service to be provided in a cloud form, or to a Provider. In addition, the term “server device” is assumed to refer to at least one computer (or a set of computers) that mainly provides a computing service in computing. In other words, the term “server device” in the present description may refer to a single computer or may refer to a set (group) of computers.

B. System Operation Example

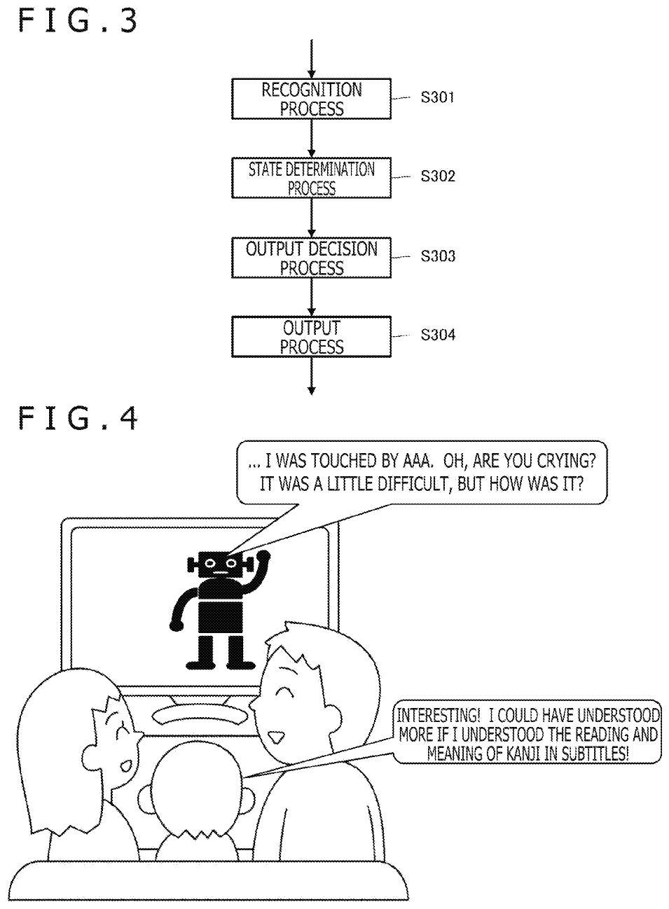

FIG. 3 depicts a schematic process flow for implementing the proactive speech making function in the interaction system 100 depicted in FIG. 1. It is to be understood that the interaction system 100 depicted in FIG. 2 implements the proactive speech making function through the same process flow.

The recognition section 101 recognizes the state of a user on the basis of a sensor signal from the sensor section 106, and further, recognizes an operation state of the external apparatus 110 (step S301).

For example, the recognition section 101 can recognize that movie content are being reproduced on a television device with a Blu-ray disk player which is the external apparatus 110. In addition, through image recognition of an image taken by a camera, the recognition section 101 can recognize that family members including a user (three people including parents and a kid) are watching movie content (movie AAA) being reproduced.

Thereafter, the recognition section 101 can recognize that reproduction of the move content is finished. In addition, through image recognition of an image taken by the camera, the recognition section 101 can recognize that the visual line of a family member is averted from a screen on which the movie has been reproduced, or the family members have substantially not had any conversation yet after reproduction of the movie content was finished.

The state determination section 102 determines the state of the user or the user's family member having an interaction with the interaction system 100, on the basis of the recognition result obtained by the recognition section 101 (step S302). In addition, the state determination section 102 consults the history database 107, as appropriate.

For example, on the basis of the recognition result indicating that reproduction of the movie content is finished and that the family members have substantially not had any conversation yet although the visual line of the family member is averted from the screen on which the movie was reproduced, the state determination section 102 can determine that the family members including the user in front of the television device are quietly basking in the afterglow.

Further, the output decision section 103 decides an interaction action of the interaction system 100, such as a timing for talking to the user, a condition for talking to the user, and a speech for talking to the user, etc., on the basis of the state determined by the state determination section 102 (step S303).

For example, on the basis of the state in which the user is basking in the afterglow of the movie, the output decision section 103 decides to make an inquiry about “whether kids can also enjoy the movie AAA.” Then, by taking the above state into consideration, the output decision section 103 decides to output “an inquiry to a kid who is beside parents” in a mode of a “tone for keeping quiet afterglow” and creates an interaction speech by consulting the interaction database 108.

Thereafter, the output generation section 104 generates the output decided by the output decision section 103, and the output section 105 executes the output generated by the output generation section 104 (step S304).

For example, the output section 105 outputs, through the loudspeaker, a voice of the interaction speech decided by the output decision section 103. Further, an interaction may be conducted through a character which is displayed on the screen of the television device. In an example depicted in FIG. 4 among three family members who have watched a movie AAA together, a kid is specified as an interaction partner. Then, through a character displayed on a screen of a television device, the interaction system 100 talks to the kid, saying “. . . I was touched by AAA. Oh, are you crying? It was a little difficult, but how was it?” In response to this, the says “Interesting! I could have understood more if I understood the reading and meaning of Kanji in subtitles!” The speech made by the kid is collected by a microphone included in the sensor section 106, voice recognition of the sound of the kid's speech is performed by the recognition section 101, and further, a state is determined by the state determination section 102. Accordingly, the speech is utilized for a next action of the interaction system 100.

With the proactive speech making function depicted in FIG. 3, the interaction system 100 can acquire much more user information in more detail. In addition, the interaction s 100 is capable of acquiring a wide variety of user information from a silent majority and asking a withdrawal user why the user has quitted proactively using the apparatus or the service.

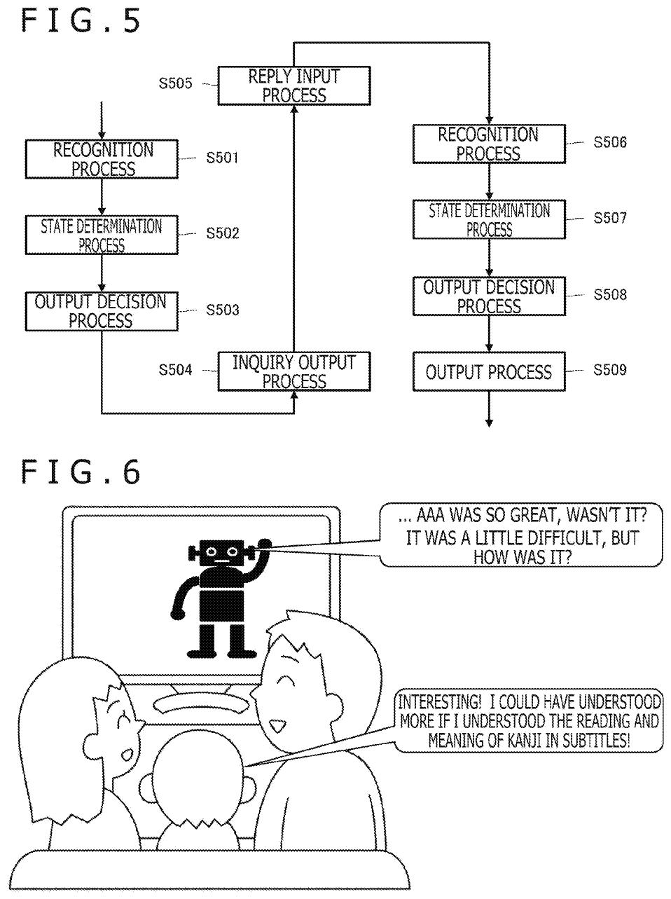

FIG. 5 depicts a schematic process flow for implementing, in the interaction system 100 depicted in FIG. 1, the feedback function of talking to a user to report a response result or a response state after responding to the reply result from the user. The feedback function is implemented subsequent to the proactive speech making function. It is to be understood that the interaction system 100 depicted in FIG. 2 implements the proactive speech making function through the same process flow.

On the basis of a sensor signal from the sensor section 106, the recognition section 101 recognizes the state of a user, and further, recognizes an operation state of the external apparatus 110 (step S501).

For example, the recognition section 101 recognizes family members who are in a living room from an image taken by a camera, and further, recognizes the quantity of a family conversation through voice recognition of a voice inputted from a microphone. In addition, the recognition section 101 recognizes the operation state of the interaction system 100 and the operation state of the external apparatus 110 which is disposed in the living room.

Next, on the basis of the recognition result obtained by the recognition section 101, the state determination section 102 determines the state of the user or a user's family member having an interaction with the interaction system 100 (step S502). In addition, the state determination section 102 consults the history database 107, as appropriate.

For example, the state determination section 102 determines a state in which all the family members are gathering and they are having conversations in a relaxed atmosphere and enjoying tea without appearing not to perform a certain operation on the apparatus.

Next, on the basis of the above-described state determined by the state determination section 102, the output decision section 103 decides an interaction action of the interaction system 100, such as a timing for talking to the user, a condition for talking to the user, and a speech for talking to the user (step S503).

For example, on the basis of the state determined by the state determination section 102, the output decision section 103 decides to make an inquiry about a “commercial reduction function” which is a new function of a recording/reproducing apparatus. In addition, in view of the above state, the output decision section 103 decides to execute an output in an “afternoon tea time” mode and creates an interaction speech by consulting the interaction database 108.

Next, the output generation section 104 generates the output decided by the output decision section 103, and the output section 105 executes the output generated by the output generation section 104 (step S504). Here, it is assumed that an inquiry speech is given by the output. section 105 to a particular user. Further, it is assumed that the user gives a reply in response to the inquiry.

The microphone included in the sensor section 106 collects the sound of a reply made by the user (step S505). The recognition section 101 performs a voice recognition process of the speech collected from the user by the microphone (step S506). Here, the sound is recognized as a reply made by a speech making person in response to an inquiry about a “commercial reduction function” which is a new function of the recording/reproducing apparatus.

Next, on the basis of the recognition result obtained by the recognition section 101, the state determination section 102 determines the state of the speech making person (step S507). For example, on the basis of the reply made by the speech making person in response to the inquiry about the “commercial reduction function,” the state determination section 102 determines a state in which “an appropriate length of a commercial for this family is 30 seconds in TV dramas and movies and is 10 seconds in the other content.”

The interaction system 100 executes a response process on the basis of the determination result obtained by the state determination section 102. In a case where the appropriate length of a commercial is determined, as described above, setting of the “commercial reduction function” based on the determination result is automatically performed for the recording/reproducing apparatus which is connected as the external apparatus 110. The setting for the external apparatus 110 may be performed by the output decision section 103 or may be performed by the state determination section 102.

Next, on the basis of the state determined by the state determination section 102, the output decision section 103 decides an interaction action of the interaction system 100, such as a timing for talking to the user, a condition for talking to the user, and a speech for talking to the user (step S508).

As described above, immediately after responding to a questionnaire reply result from the user, the output decision section 103 decides a timing for talking to the user, a condition for talking to the user, and a speech for talking to the user for the response result and the response state. In addition, in view of the state of having responded to the reply result from the user, the output decision section 103 decides to execute an output in a mode for “reporting the state” and “also teaching a change method” and creates an interaction speech by consulting the interaction database 108.

Next, the output generation section 104 generates the output decided by the output decision section 103, and the output section 105 executes the output generated by the output generation section 104 (step S509). Here, the output section 105 talks to the user and reports the response result and the response state.

According to the process procedures depicted in FIG. 5, the interaction system 100 can implement the feedback function of talking to a user and reporting a response result or a response state after responding to the reply result from the user. With such a feedback function, motivation for the user to give a reply to talking started by the interaction system 100 can be increased so that a barrier for the interaction system 100 to ask the user's opinion may be lowered. In addition, the opinion can be utilized for improvement of an apparatus having the interaction system 100 installed therein or a service.

C. Operation Examples of Proactive Speech Making Function

The interaction system 100 according to the present embodiment has the proactive speech making function of proactively talking to a user at a timing according to the context and by using a subject according to the context, on the basis of the state and the tendency of the user and the history. Some specific examples of implementing the proactive speech making function in the interaction system 100 will be explained.

C-1. Proactive Speech Based on Deterioration of Concentration of Visual Line

The recognition section 101 can recognize a content reproduction state of a content reproducing apparatus serving as the external apparatus 110, and any other apparatus operation states. In addition, the recognition section 101 can perform voice recognition of a voice inputted from a microphone and can recognize the visual line of a user from a camera image. The recognition section 101 recognizes that concentration of the visual line of a user who finished watching a movie or a TV drama is averted from a content reproduction screen, and that the user has not have any conversation or has not operated any other apparatuses. On the basis of such a recognition result, the state determination section 102 determines that “concentration of the visual line of the user on the content has been deteriorated, but the user is basking in the afterglow because the user is still in front of the reproducing apparatus, and therefore, it is a timing for asking an opinion of the content.” Then, on the basis of such a determination result, the output decision section 103 decides an interaction action of asking the user's opinion and creates an interaction speech by consulting the interaction database 108. The output generation section 104 generates the output decided by the output decision section 103, and the output section 105 executes the output generated by the output generation section 104.

In the example depicted in FIG. 6, on the basis of a recognition result indicating that three family members have finished watching a movie AAA, the visual lines of the family members are averted from the screen, and the family members have had no conversation or operated another apparatus, the interaction system 100 determines that “concentration of the visual lines of the user on the content has been deteriorated, but the user is basking in the afterglow because the user is still in front of the reproducing apparatus, and therefore, it is a timing for asking an opinion of the content.” Then, the interaction system 100 specifies the kid as an interaction partner, and asks the kid, “. . . AAA was so great, wasn't it? It was a little difficult, but how was it?” through a character displayed on the screen of the television device. In response to this, the kid says “Interesting! I could have understood more if I understood the reading and meaning of Kanji in subtitles!” The sound of the speech made by the kid is collected by the microphone included in the sensor section 106, voice recognition of the sound of the kid's speech is performed by the recognition section 101, and the state is determined by the state determination section 102. Accordingly the speech is utilized for a next action of the interaction system 100.

As a result of making the above proactive speech, the interaction system 100 can obtain a feedback from the user without hindering the user's watching action or a user's next action before the user's memory of the experience becomes vague. It is considered that users who proactively give feedbacks after finishing watching actions are limited. Therefore, the interaction system 100 according to the present embodiment characterized by being able to obtain feedbacks from a wide variety of users, compared to the conventional interaction system in which a user's action of talking to the system is a trigger.

C-2. Proactive Speech Based on Positional Information

The recognition section 101 can recognize the location of a user through information regarding the position of the mobile apparatus 120 being carried by the user and through recognition of a camera image. For example, from information regarding the position of the mobile apparatus 120 and a camera image, the recognition section 101 recognizes that a user actually visited a place (e.g., a restaurant) recommended for the user by the interaction system 100 and that the user came home from the place. On the basis of such a recognition result, the state determination section 102 determines that it is a timing for asking an opinion about the restaurant. Then, on the basis of such a determination result, the output decision section 103 decides an interaction action of asking the user's opinion and creates an interaction speech by consulting the interaction database 108. The output generation section 104 generates the output decided by the output decision section 103, and the output section 105 executes the output generated by the output generation section 104.

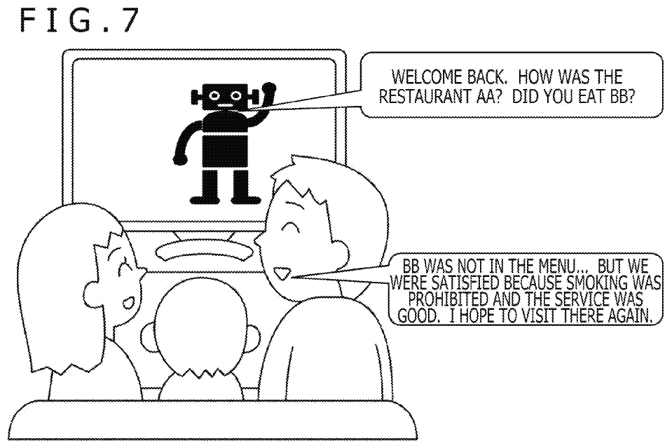

In the example depicted in FIG. 7, on the basis of a recognition result indicating that a family of three went to a restaurant AA and came back home from the restaurant, the interaction system 100 asks the father, “Welcome back. How was the restaurant AA? Did you eat KOKO?” In response to this, the farther says “BB was not in the menu. But we were satisfied because smoking was prohibited and the service was good. I hope to visit there again.” The sound of the speech made by the father is collected by the microphone included in the sensor section 106, voice recognition of the sound of the father's speech is performed by the recognition section 101, and further, the state is determined by the state determination section 102. Accordingly, the speech utilized for a next action of the interaction system 100.

As a result of making the above proactive speech, the interaction system 100 can obtain a feedback in response to a recommendation technology provided by the interaction system 100, a feedback about a place the user has visited or a restaurant, and user's preference information before the user's memory of an experience becomes vague. In addition, it is considered that users who proactively give feedbacks in response to a recommendation technology are limited. Therefore, the interaction system 100 according to the present embodiment is characterized by being able to obtain feedbacks from a wide variety of users, compared to the conventional interaction system in which a user's action of talking to the system is a trigger.

C-3. Proactive Speech Based on State in which there is No Conversation

The recognition section 101 can recognize an operation which a user is performing and whether or not the user is having any conversation, through image recognition of a camera image and voice recognition of a voice inputted from a microphone. For example, through the image recognition and the voice recognition, the recognition section 101 recognizes that a state in which the user is having a meal with one or more family members but the user and the family members are not having any conversation continues. On the basis of such a recognition result, the state determination section 102 determines that the interaction system 100 can proactively talk to the user. Then, on the basis of such a determination result, the output decision section 103 decides to start a conversation with the user about a questionnaire or the like and creates the questionnaire consulting the interaction database 108. The output generation section 104 generates an output decided by the output decision section 103, and the output section 105 executes the output generated by the output generation section 104.

As a result of making the above proactive speech, the interaction system 100 can promote the user's conversation, rather than obstruct the user's conversation. In addition, it is considered that users who proactively give feedbacks in a state in which there is no conversation are limited. Therefore, the interaction system 100 according to the present embodiment is characterized by being able to obtain feedbacks from a wide variety of users, compared to the conventional interaction system in which a user's action of talking to the system is a trigger.

C-4. Proactive Speech Based on Sensing of User's Action

The recognition section 101 can recognize a music reproduction state of a music reproducing apparatus serving as the external apparatus 110 and can recognize a song which a user often listen to. For example, through recognition of the operation state of the music reproducing apparatus and recognition of an image, the recognition section 101 recognizes that a user who often listens to songs of a particular artist is in a room, and the user starts to reproduce a song of the artist but stops the song soon. On the basis of such a recognition result, the state determination section 102 determines that the interaction system 100 can proactively ask the user why the user took a different action than usual. Then, on the basis of such a determination result, the output decision section 103 decides an interaction action of asking why the user stopped the song and creates an interaction speech by consulting the interaction database 108. The output generation section 104 generates an output decided by the output decision section 103, and the output section 105 executes the output generated by the output generation section 104.

As a result of making the above proactive speech, the interaction system 100 can obtain more detailed user information, or information that is difficult to obtain from an apparatus operation log. The information indicates, for example, that “the user do not want listen to music with words when reading,” “the user still likes the artist,” and “the user does not dislike the song.” In addition, it is considered that users who proactively give feedbacks on why the users took different actions than usual are limited. Therefore, the interaction system 100 according to the present embodiment characterized by being able to obtain feedbacks from a wide variety of users, compared to the conventional interaction system in which a user's action of talking to the system is a trigger.

C-5. Proactive Speech Based on Sensing of Apparatus Operation

The recognition section 101 can recognize various states of operations on the external apparatus 110 which is connectable to the interaction system 100. For example, from the log of the states of operations on the external apparatus 110, the recognition section 101 recognizes that a user has not operated the apparatus for a long time, or that only a particular function of the apparatus is being used. On the basis of such a recognition result, the state determination section 102 determines that the interaction system 100 can proactively ask the user why the user stopped operating the apparatus or why the user performed the exceptional (or unusual) apparatus operation. Then, on the basis of such a determination result, the output decision section 103 decides an interaction action of asking why the user stopped the apparatus operation or performed the exceptional apparatus operation and creates an interaction speech by consulting the interaction database 108. The output generation section 104 generates an output decided by the output decision section 103, and the output section 105 executes the output generated by the output generation section 104.

In addition, the recognition section 101 can recognize a user's use state of a service provided by the interaction system 100 or a service linked with the interaction system 100. For example, the recognition section 101 recognizes, from the use state log, that the user has quitted using the service for a long time, or that the user is using only a part of the service. On the basis of such a recognition result, the state determination section 102 determines that the interaction system 100 can proactively ask whether or not the user has lost interest in the service or why the user has lost interest in the service. Then, on the basis of such a determination result, the output decision section 103 decides an interaction action of asking why the user stopped an apparatus operation or why the user performed an exceptional apparatus operation and creates an interaction speech by consulting the interaction database 108. The output generation section 104 generates an output decided by the output decision section 103, and the output section 105 executes the output generated by the output generation section 104.

As a result of making the above proactive speech, the interaction system 100 can obtain an opportunity to appeal to the user who lost or is losing interest in the apparatus or the service In addition, it is considered that users who proactively give feedbacks on why the users lost or are losing interest in an apparatus or service are limited. Therefore, the interaction system 100 according to the present. embodiment is characterized by being able to obtain feedbacks from a wide variety of users, compared to the conventional interaction system in which a user's action of talking to the system is a trigger.

With the proactive speech making function, the interaction system 100 according to the present embodiment can acquire much more user information in more detail. In addition, the interaction system 100 can acquire a wide variety of user information from a silent majority, and can ask a withdrawal user why the user has quitted proactively using the apparatus or the service.

D. Operation Examples of Feedback Function

The interaction system 100 according to the present embodiment has the feedback function of talking to a user and reporting a response result or response state after responding to the reply result from the user. Here, some specific examples of implementing the feedback function in the interaction system 100 will be explained.

D-1. Case of Reflecting Reply Result from User in Apparatus Setting

The interaction system 100 conducts a questionnaire about the external apparatus 110 or a service, for example, to a user, and reflects a questionnaire reply result from the user in setting of the external apparatus 110 and the service.

For example, when a “commercial reduction function” is implemented as a new function of a recording/reproducing apparatus which is one example of the external apparatus 110, the output decision section 103 decides to conduct a questionnaire about the commercial reduction function to a user who usually fast-forwards commercials, specifying the user as an interaction partner. Then, the questionnaire is conducted to the user through the output generation section 104 and the output section 105.

The sound of a questionnaire reply from the user is collected by a microphone, and voice recognition of the sound is performed by the recognition section 101. Then, on the basis of the recognition result, the state determination section 102 determines that an appropriate length of a commercial for the user is 30 seconds in TV dramas and movies and is 10 seconds in the other content. Then, setting of the “commercial reduction function” based on the determination result is automatically performed for the recording/reproducing apparatus. Accordingly, the questionnaire reply is reflected in the external apparatus 110 and the service.

Immediately after responding to the questionnaire reply result from the user, the output decision section 103 decides a timing for talking to the user, a condition for talking to the user, and a speech for talking to the user, for the response result and the response state. Then, talking to the user is started, and the response result and the response state to questionnaire reply are reported through the output generation section 104 and the output section 105. As a result, motivation for the user to give a reply o talking started by the interaction system 100 can be increased so that a barrier for the interaction system 100 to ask the user's opinion may be lowered. In addition, the opinion can be utilized for improving an apparatus having the interaction system 100 installed therein or a service.

D-2. Case of Asking User's Dissatisfaction and Reflecting Dissatisfaction in Improvement of Apparatus or Service

The interaction system 100 conducts a questionnaire about the external apparatus 110 or a service, for example, to a user, reflects a questionnaire reply result from the user in improvement of the external apparatus 110 and the service, and gives a report to the user.

For example, the output decision section 103 decides to ask the user about dissatisfaction in services provided by the external apparatus 110 and the interaction system 100. A questionnaire about the dissatisfaction is conducted to the user through the output, generation section 104 and the output section 105.

The sound of a reply from the user is collected by a microphone, and voice recognition of the sound is performed by the recognition section 101. Then, on the basis of the recognition result, the state determination section 102 determines release of improvement software or any other alternatives, which is needed for the external apparatus 110 or a provider of the service to eliminate the user's dissatisfaction.

Regarding the release of improvement software or any other alternatives for eliminating the user's dissatisfaction, the output decision section 103 decides a timing for talking to the user, a condition for talking to the user, and a speech for talking to the user. Then, talking to the user is started, and the release of improvement software or any other alternatives is reported, through the output generation section 104 and the output section 105. As a result of the report to the user, the user can become aware of improvement of the external apparatus 110 or the services after being talked to by the interaction system 100. Accordingly, motivation for the user to give a reply to talking started by the interaction system 100 can be increased so that a barrier for the interaction system 100 to ask the user's opinion may be lowered.

Alternatively, the output decision section 103 decides to ask plural users about a function desired to be added to or a function which can be deleted from the external apparatus 110 or a service provided by the interaction system 100, and a questionnaire is conducted to the users through the output generation section 104 and the output section 105. Then, the sounds of replies from the users are collected by a microphone, and voice recognition of the sounds is performed by the recognition section 101. On the basis of the recognition result, the state determination section 102 compiles the questionnaire replies.

Regarding the vote result on a function to be developed next or a function that can be deleted, the output decision section 103 decides a timing for talking to the users, a condition for talking to the users, and a speech for talking to the users. Then, talking to the user is started, and release of improvement software or any other alternatives is reported, through the output generation section 104 and the output section 105.

In addition, in a case where the external apparatus 110 or a provider of the service updates and releases the software on the basis of the vote results of users, the state determination section 102 determines this state, and the output decision section 103 decides a timing for talking to the users, a condition for talking to the users, and a speech for talking to the users, regarding release of the software. Then, talking to the user is started, and release of the software is reported, through the output generation section 104 and the output section 105. As a result of the report to the users, the users can become aware of improvement in the external apparatus 110 or the service by the talk started by the interaction system 100. Accordingly, motivation for the users to give a reply to talking started by the interaction system 100 can be increased so that a barrier for the interaction system 100 to ask the users' opinions may be lowered.

With the feedback function, the interaction system 100 according to the present embodiment can increase motivation for a user to give a reply to talking started by the interaction system 100 so that a barrier for the interaction system 100 to ask the user's opinion may be lowered. In addition, the opinion can be utilized for improving an apparatus having the interaction system 100 installed therein or the service.

E. Effects of Interaction System

Finally, conclusions of the effects of the interaction system 100 according to the present embodiment will be given.

In the conventional interaction system in which an interaction with a user is started by, as a trigger, a user's action of talking to the system, the system cannot obtain user information or a questionnaire reply unless the user talks to the system. Thus, opportunities to acquire information from the user and the contents of the information are limited. This causes a problem that the quality and quantity of acquirable user information and questionnaire replies are insufficient. Moreover, variation is generated in the number of replies among users, and statistical information is difficult to acquire. Furthermore, it is difficult to appeal to a withdrawal user who does not use the external apparatus 110 or the service for a long time, by, for example, asking the withdrawal user why the user does not use the external apparatus 110 or the service.

On the other hand, the interaction system 100 according to the present embodiment can proactively start talking to a user in view of the state or the tendency of the user. Therefore, an effect that the interaction system 100 can acquire much more user information in more detail, can acquire a wide variety of user information from a silent majority, and can ask a withdrawal user why the user has quitted proactively using the apparatus or service, can be provided.

In addition, the conventional interaction system basically does not include a mechanism for sending, to a user, a feedback about how user information is used after being collected through an interaction. Thus, a reward the user can obtain for a response made in response to an inquiry from the interaction system is the pleasure of an interaction only. Since motivation to give a reply is weak, there is a concern about reduction in the reply rate. Moreover, a reply result from the user cannot be utilized for experience itself of the apparatus or the service.

On the other hand, the interaction system 100 according to the present embodiment can respond to a reply result from a user and can talk to the user and report the response result or response state. Therefore, motivation for the user to give a reply to talking started by the interaction system can be increased so that a barrier for the interaction system to ask the user's opinion may be lowered. Further, the opinion can be utilized for improving an apparatus having the interaction system 100 installed therein or a service itself.

### INDUSTRIAL APPLICABILITY

The technology disclosed in the present description has been explained in detail so far with reference to the specific embodiment. However, it is obvious that a person skilled in the art can make modification or substitution on the embodiment within the gist of the technology disclosed in the present description.

In the present description, the technology disclosed herein has been explained mainly on the basis of the embodiment in which the technology is applied to an interaction system called “agent” or “assistant.” However, the gist of the technology disclosed in the present description is not limited to this embodiment. For example, technology disclosed present description is also applicable to a questionnaire data collecting system for collecting questionnaire replies so that much more questionnaire replies can be collected in more detail.

In short, the technology disclosed in the present description has been explained in a form of exemplifications, and thus, the disclosure in the present description should not be limitedly interpreted. In order to assess the gist of the technology disclosed herein, the claims should be considered.

It is to be noted that the technology disclosed in the present description also may have the following configurations.
(1)

An information processing device including:

a determination section that determines a state or a tendency of a user; and

a decision section that decides an output to the user on the basis of a determination result obtained by the determination section.
(2)

The information processing device according to (1), in which

the determination section determines the state or the tendency of the user on the basis of a recognition result about the user or operation of an apparatus being used by the user.
(3)

The information processing device according to or (2), in which

the determination section determines a use state of the apparatus, respective positions and respective directions of the user and family members in a room, a direction of a face, a movement amount, a visual line, a facial expression, respective positions of the respective family members outside the room, respective conversation quantities of the user and the family members, a relative volume of a conversation sound, an emotion, and what is talked about in the conversation.
(4)

The information processing device according to any one of (1) to (3), in which

the decision section decides a timing for talking to the user, a condition for talking to the user, or a speech for talking to the user.
(5)

The information processing device according to any one of (1) to (4), in which

the determination section determines a concentration degree of the visual line of the user, and

the decision section decides the output to the user on the basis of deterioration in the concentration of the visual line of the user.
(6)

The information processing device according to any one of (1) to (5), in which

the determination section determines the state of the user on the basis of positional information regarding the user, and

the decision section decides the output to the user on the basis of a determination result according to the positional information regarding the user.
(7)

The information processing device according to any one of (1) to (6), in which

the determination section determines the state of the user on the basis of a conversation state, and

the decision section decides the output to the user on the basis of a determination result according to the conversation state.
(8)

The information processing device according to any one of (1) to (7), in which

the determination section determines the state of the user on the basis of a change in the user or a change in operation of an apparatus being used by the user, and

the decision section decides the output to the user on the basis of a determination result according to the change.
(9)

The information processing device according to any one of (1) to (8), in which

the determination section determines the state of the user on the basis of what operation the user performs on an apparatus or a tendency of the operation, and

the decision section decides the output to the user on the basis of a determination result according to what apparatus operation is performed by the user or the tendency of the apparatus operation.
(10)

The information processing device according to any one of (1) to (9), in which

the determination section determines a reply made by the user in response to an inquiry of the output decided by the decision section and performs a response process.
(11)

The information processing device according to (10), in which

the determination section determines a state or a result of the response process, and

the decision section decides to output the state or the result of the response process to the user.
(12)

The information processing device according to (10), in which

the determination section determines setting of a new function of an apparatus or a service on the basis of a reply made by the user in response to a questionnaire about the new function.
(13)

The information processing device according to (12), in which

the decision section decides to output, to the user, a response state or a response result of the reply made by the user.
(14)

The information processing device according to (10), in which

the determination section determines release of improvement software or any other alternatives on the basis of a reply made by the user in response to a questionnaire about dissatisfaction with an apparatus or a service.
(15)

The information processing device according to (14), in which

the decision section decides an output for reporting the release of the improvement software or the other alternatives to the user.
(16)

An information processing method including:

a determination step of determining a state or a tendency of a user; and

a decision step of deciding an output to the user on the basis of a determination result obtained by the determination step.
(17)

A computer program that is written in a computer readable form to cause a computer to function as

a determination section that determines a state or a tendency of a user, and

a decision section that decides an output to the user on the basis of a determination result obtained by the determination section.
(18)

An interaction system including:

a recognition section that performs a recognition process of a user or operation of an apparatus being used by the user;

a determination section that determines a state or a tendency of the user on the basis of a recognition result obtained by the recognition section;

a decision section that decides an output to the user on the basis of a determination result obtained by the determination section; and

an output section that executes the output to the user on the basis of the decision.

### REFERENCE SIGNS LIST

100: Interaction system

101: Recognition section

102: State determination section

103: Output decision section

104: Output generation section

105: Output section

106: Sensor section

107: History database

108: Interaction database

1. An information processing device comprising:
a determination section that determines a state or a tendency of a user; and
a decision section that decides an output to the user on a basis of a determination result obtained by the determination section.

2. The information processing device according to claim 1, wherein
the determination section determines the state or the tendency of the user on a basis of a recognition result about the user or operation of an apparatus being used by the user.

3. The information processing device according to claim 1, wherein
the determination section determines a use state of the apparatus, respective positions and respective directions of the user and family members in a room, a direction of a face, a movement amount, a visual line, a facial expression, respective positions of the respective family members outside the room, respective conversation quantities of the user and the family members, a relative volume of a conversation sound, an emotion, and what is talked about in the conversation.

4. The information processing device according to claim 1, wherein
the decision section decides a timing for talking to the user, a condition for talking to the user, or a speech for talking to the user.

5. The information processing device according to claim 1, wherein
the determination section determines a concentration degree of the visual line of the user, and
the decision section decides the output to the user on a basis of deterioration in the concentration of the visual line of the user.

6. The information processing device according to claim 1, wherein
the determination section determines the state of the user on a basis of positional information regarding the user, and
the decision section decides the output to the user on a basis of a determination result according to the positional information regarding the user.

7. The information processing device according to claim 1, wherein
the determination section determines the state of the user on a basis of a conversation state, and
the decision section decides the output to the user on a basis of a determination result according to the conversation state.

8. The information processing device according to claim 1, wherein
the determination section determines the state of the user on a basis of a change in the user or a change in operation of an apparatus being used by the user, and
the decision section decides the output to the user on a basis of a determination result according to the change.

9. The information processing device according to claim 1, wherein
the determination section determines the state of the user on a basis of what operation the user performs on an apparatus or a tendency of the operation, and
the decision section decides the output to the user on a basis of a determination result according to what apparatus operation is performed by the user or the tendency of the apparatus operation.

10. The information processing device according to claim 1, wherein
the determination section determines a reply made by the user in response to an inquiry of the output decided by the decision section and performs a response process.

11. The information processing device according to claim 10, wherein
the determination section determines a state or a result of the response process, and
the decision section decides to output the state or the result of the response process to the user.

12. The information processing device according to claim 10, wherein
the determination section determines setting of a new function of an apparatus or a service on a basis of a reply made by the user in response to a questionnaire about the new function.

13. The information processing device according to claim 12, wherein
the decision section decides to output, to the user, a response state or a response result of the reply made by the user.

14. The information processing device according to claim 10, wherein
the determination section determines release of improvement software or any other alternatives on a basis of a reply made by the user in response to a questionnaire about dissatisfaction with an apparatus or a service.

15. The information processing device according to claim 14, wherein
the decision section decides an output for reporting the release of the improvement software or the other alternatives to the user.

16. An information processing method comprising:
a determination step of determining a state or a tendency of a user; and
a decision step of deciding an output to the user on a basis of a determination result obtained by the determination step.

17. A computer program that is written in a computer readable form to cause a computer to function as:
a determination section that determines a state or a tendency of a user; and
a decision section that decides an output to the user on a basis of a determination result obtained by the determination section.

18. An interaction system comprising:
a recognition section that performs a recognition process of a user or operation of an apparatus being used by the user;
a determination section that determines a state or a tendency of the user on a basis of a recognition result obtained by the recognition section;
a decision section that decides an output to the user on a basis of a determination result obtained by the determination section; and
an output section that executes the output to the user on a basis of the decision.
